(19) United States
(12) Patent Application Publication
(10) Pub. No.: US 2005/0013757 A1
(43) Pub. Date: Jan. 20, 2005

(54) Method and system for removing sulfur and dust from waste gases, particularly refinery waste gases

(76) Inventors: Franz Windschmitt, Maintal (DE); Gebhard Bandel, Essen (DE)

Correspondence Address: WILLIAM COLLARD;COLLARD & ROE, P.C., 1077 NORTHERN BOULEVARD, ROSLYN, NY, 11576, US

(21) Appl. No.: 10/654,654

(22) Filed: Sep. 3, 2003

(30) Foreign Application Priority Data
Jul. 16, 2003 (DE) 103 32 2590

(51) Int. Cl. B01D 53/50

(52) U.S. Cl. 423/242.1; 422/171; 422/170; 422/172; 422/174

(57) ABSTRACT

A method and system for removing sulfur and dust from waste gases, particularly refinery waste gases, wherein the waste gas to be cleaned is passed to a scrubbing tower above a scrubber sump and, in order to remove SO₂ and acidic gases, scrubbed in a scrubbing zone of the scrubbing tower, in counter-current with a scrubbing fluid that is drawn from the scrubber sump and passed to spray nozzles at the upper end of the scrubbing zone. Sulfites contained in the scrubber sump are oxidized to form sulfates, by means of gasification with air in the scrubber sump or in an external device assigned to the scrubber sump. A suspension stream is drawn from the scrubber sump. The gas that leaves the scrubbing zone flows through a wet electrofilter arranged above the scrubbing zone in the scrubbing tower, whereby dust particles and aerosols and entrained droplets are collected on precipitation electrodes of the wet electrofilter. The precipitation electrodes are periodically flushed with a partial stream of the scrubbing fluid, which is taken from the scrubber sump, applied at the head of the wet electrofilter and then enters the scrubber sump.

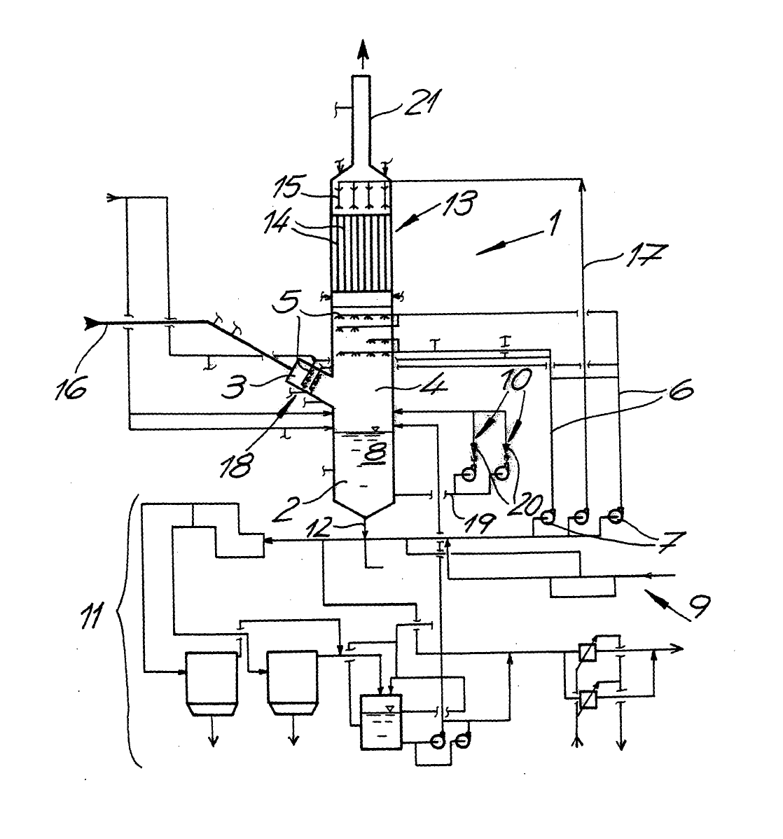

### CROSS REFERENCE TO RELATED APPLICATIONS

Applicants claim priority under 35 U.S.C. §119 of German Application No. 103 32 259.0 filed Jul. 16, 2003.

### BACKGROUND OF THE INVENTION

1. Field of the Invention

The invention relates to a method for removing sulfur and dust from waste gases, particularly refinery waste gases, wherein the waste gas to be cleaned is passed to a scrubbing tower above a scrubber sump and scrubbed in a scrubbing zone of the scrubbing tower, in counter-current with a scrubbing fluid that is drawn from the scrubber sump and passed to spray nozzles at the upper end of the scrubbing zone, in order to remove SO₂ and acidic gases. Sulfites contained in the scrubber sump are oxidized to form sulfates, by means of gasification with air in the scrubber sump or in an external device assigned to the scrubber sump, and a suspension stream is drawn from the scrubber sump. The invention particularly relates to the removal of sulfur and dust from waste gases from FCC (fluid catalytic cracking) systems in refineries.

2. The Prior Art

FCC systems continuously clean catalysts in fluidized bed methods. Known methods having the characteristics described initially are frequently operated with soda lye (NaOH) or a sodium carbonate solution (Na₂CO₃) as the absorbent. In this way, SO₂ and acidic gases can be removed with a high degree of effectiveness, but the removal of dust and H₂SO₄ aerosols is limited. In order to improve the dust removal, scrubbing is therefore frequently combined with mechanical collectors (Venturi collectors and/or centrifugal force collectors). A disadvantage of these collectors is their high flow pressure loss and their limited degree of removal of dust and entrained droplets. Furthermore, the use of horizontal dry-bed electrofilters for gas purification is known, but these are only suitable for dust removal.

### SUMMARY OF THE INVENTION

It is therefore an object of the invention to provide a method having the characteristics described initially, which also allows simple and effective removal of dust and aerosols, at low pressure loss.

According to the invention, the gas that leaves the scrubbing zone flows through a wet electrofilter arranged above the scrubbing zone in the scrubbing tower. Dust particles and aerosols and entrained droplets are collected on precipitation electrodes of the wet electrofilter, and the precipitation electrodes are periodically flushed with a partial stream of the scrubbing fluid, which is taken from the scrubber sump, applied at the head of the wet electrofilter, and then gets into the scrubber sump. In comparison with the state of the art, this results in a particularly efficient removal of dust particles, aerosols, and entrained droplets. The wet electrofilter allows high levels of removal of dust and aerosols, up to above 99%. Because of the use of the scrubbing fluid both as an absorbent and as a flushing fluid in the wet electrofilter, both the transport and the treatment of the scrubbing fluid can be structured with a simple design. The entire method causes only a slight pressure drop. Since the wet electrofilter is integrated into the scrubbing tower above the scrubbing zone, this results in clear advantages with regard to the apparatus costs of the method. Mechanical collectors to remove dust, H₂SO₄ aerosols, and entrained droplets are no longer required.

Preferably, absorbents are added to renew the scrubbing fluid in a scrubbing fluid circulation system that connects the scrubber sump with the spray nozzles at the upper end of the scrubbing zone. This allows equalization of the absorbent loss caused by the reaction with the acidic gas components. Preferably, NaOH, Na₂CO₃, CaCO₃, Ca(OH)₂, as a sole absorbent or in mixtures, in each instance, are used as absorbents for the scrubbing fluid. These absorbents are relatively inexpensive and have proven themselves in the technology.

According to a preferred embodiment of the invention, the flushing fluid that leaves the wet electrofilter enters the scrubber sump through the scrubbing zone. This has the advantage that the scrubbing fluid can additionally be used as a detergent in the scrubbing process. Alternatively, however, it is also possible to collect the scrubbing fluid below the wet electrofilter and to pass it to the scrubber sump directly.

The waste gas to be cleaned can have scrubbing fluid applied to it in a quench stage that precedes the scrubbing zone. This quench stage is arranged on the gas inlet of the scrubbing tower, and cooled to approximately saturation temperature. In this way, the gas load is reduced in the region of the gas inlet of the scrubbing tower. Preferably, the work is carried out in the scrubbing tower at a gas-side pressure loss of less than 15 hPa. This low pressure loss can be achieved because mechanical collectors are eliminated, and reduces the investment and energy costs in the region of the waste gas blowers.

Preferably, oxidation of the primary sulfite and hydrogen sulfite formed, to sulfate, takes place in the integrated scrubber sump. For this purpose, a fluid stream is preferably drawn from the scrubber sump, mixed with air, using water jet pumps, and passed back to the scrubber sump. As an alternative to this, the oxidation air can be produced by compressors and distributed in the scrubber sump by way of nozzle lances.

The gas leaving the wet electrofilter can be passed off into the environment by means of a chimney arranged above the filter. This direct exhaust of gas into the environment allows a method that is particularly low in pressure loss, which is furthermore cost-effective and saves space.

A system for carrying out the method is also an object of the invention.

### BRIEF DESCRIPTION OF THE DRAWING

In the following, the invention will be explained in greater detail using a drawing that merely represents an exemplary embodiment.

The single FIGURE schematically shows a method according to the invention, for removing sulfur and dust from waste gases, particularly refinery waste gases.

### DETAILED DESCRIPTION OF THE PREFERRED EMBODIMENT

In the exemplary embodiment, the method according to the invention cleans waste gases in an FCC system in a refinery. The system shown has a scrubbing tower 1, which has a scrubber sump 2, a gas inlet 3 above the scrubber sump 2, and a scrubbing zone 4 with spray nozzles 5 at the upper end of the scrubbing zone 4. A scrubbing fluid circulation system 6 is provided, which connects scrubber sump 2 with spray nozzles 5 and has a device 7 to transport scrubbing fluid 8 from scrubber sump 2 to spray nozzles 5. Furthermore, a metering device 9 for absorbents, and devices 10, 11 for gasification of the scrubbing fluid 8 with air, and for thickening a suspension stream 12 that is drawn from the scrubber sump 2, are provided. A wet electrofilter 13 having precipitation electrodes 14 and spray electrodes, through which vertical flow takes place, is arranged in a segment of scrubbing tower 1 above scrubbing zone 4. For periodic cleaning of the precipitation electrodes 14, a flushing device 15 is provided, which is connected with scrubbing fluid circulation system 6.

The waste gas 16 to be cleaned is passed to scrubbing tower 1 above scrubber sump 2, and scrubbed in a counter-current with scrubbing fluid 8, in scrubbing zone 4 of scrubbing tower 1, in order to remove SO₂, and acidic gases. In the exemplary embodiment, NaOH is used as an absorbent for scrubbing fluid 8. Scrubbing fluid 8 is drawn from scrubber sump 2 and passed to spray nozzles 5 at the upper end of scrubbing zone 4. Sulfites contained in scrubber sump 2 are oxidized to sulfates in gasification device 10 external to the scrubber sump, by means of gasification with air. Furthermore, suspension stream 12 is drawn from scrubber sump 2. The gas that leaves scrubbing zone 4 flows through the wet electrofilter 13 arranged in scrubbing tower 1 above scrubbing zone 4, whereby dust particles and aerosols are collected on precipitation electrodes 14 of wet electrofilter 13. Precipitation electrodes 14 are flushed with a partial stream 17 of scrubbing fluid, which is drawn from scrubber sump 2, applied at the head of wet electrofilter 13 by means of flushing device 15, and then gets into scrubber sump 2 through the electrofilter and scrubbing zone 4.

The method demonstrates a great number of advantages. The wet electrofilter 13 allows high levels of removal of dust and aerosols, up to 99%. Sulfur dioxide and acidic gases are effectively removed from waste gas 16 in scrubbing zone 4. The use of a partial stream 17 of scrubbing fluid to flush precipitation electrodes 14 is advantageous in design and allows common treatment with regard to the particles removed in wet electrofilter 13 and in scrubbing zone 4. Since no mechanical collectors are provided for removing dust and aerosols, in the method according to the invention, the method can be operated at a very low pressure loss.

Since wet electrofilter 13 is integrated into scrubbing tower 1, this results in an extremely cost-effective construction. Furthermore, the flushing fluid that runs out of wet electrofilter 13 can additionally be used as a scrubbing fluid in scrubbing zone 4.

To renew scrubbing fluid 8, absorbents are added to scrubbing fluid circulation system 6. Metering device 9 for absorbents is connected with scrubbing fluid circulation system 6. This allows equalization of the absorbent loss caused by the precipitation reaction. A quenching device 18 having spray nozzles 5, which device is connected with scrubbing fluid circulation system 6, is arranged in gas inlet 3. In quenching device 18, waste gas 16 to be cleaned has scrubbing fluid 8 applied to it, and is cooled to approximately saturation temperature. In this way, the gas load in the gas inlet region of scrubbing tower 1 is significantly reduced, and the flow behavior of gas 16 is relaxed. In scrubbing tower 1, the work is carried out at a gas-side pressure loss of less than 15 hPa.

The device 10 for gasification of scrubbing fluid 8 is arranged in a circulation line 19 connected with scrubber sump 2, and has water jet pumps 20, through which scrubbing fluid 8 flows and which draw air into fluid stream 8. In this way, oxidation of the sodium sulfite and sodium hydrogen sulfite contained in the fluid stream 8, to sodium sulfate, is promoted.

The fluid stream from the water jet pumps is passed back to the scrubber sump, in order to make oxidation complete.

Scrubbing tower 1 furthermore has a chimney 21 at the top, for emission of the gas cleaned in the wet electrofilter 13 into the environment. This direct venting into the environment allows a method that is particularly low in pressure loss, which is cost-effective and saves space.

Accordingly, while only a single embodiment of the present invention has been shown and described, it is obvious that many changes and modifications may be made thereunto without departing from the spirit and scope of the invention.

1. A method for removing sulfur and dust from waste gases, comprising:
passing the waste gas (16) to be cleaned to a scrubbing tower (1) above a scrubber sump (2); and
scrubbing the waste gases in a scrubbing zone (4) of the scrubbing tower (1), in counter-current with a scrubbing fluid (8) that is drawn from the scrubber sump (2) and passed to spray nozzles (5) at an upper end of the scrubbing zone (4) in order to remove SO₂ and acidic gases, wherein sulfites contained in the scrubber sump (2) are oxidized to form sulfates, by means of gasification with air in the scrubber sump (2) or in an external device (10) assigned to the scrubber sump (2), and wherein a suspension stream (12) is drawn from the scrubber sump (2);
causing the gas that leaves the scrubbing zone (4) to flow through a wet electrofilter (13) arranged above the scrubbing zone (4) in the scrubbing tower (1);
collecting dust particles and aerosols and entrained droplets on precipitation electrodes (14) of the wet electrofilter (13); and
periodically flushing the precipitation electrodes (14) with a partial stream (17) of the scrubbing fluid, which is taken from the scrubber sump (2), applied at the head of the wet electrofilter (13), and then enters the scrubber sump (2).

2. A method according to claim 1, wherein absorbents are added to renew the scrubbing fluid (8) in a scrubbing fluid circulation system (6) that connects the scrubber sump (2) with the spray nozzles (5) at an upper end of the scrubbing zone (4).

3. A method according to claim 1, wherein NaOH, Na₂CO₃, CaCO₃, Ca(OH)₂, as a sole absorbent or in mixtures are used as absorbents for the scrubbing fluid (8).

4. A method according to claim 1, wherein the partial stream of scrubbing fluid (17) that leaves the wet electrofilter (13) enters the scrubber sump (2) through the scrubbing zone (4).

5. A method according to claim 1, wherein the waste gas (16) to be cleaned has scrubbing fluid (8) applied to it in a quench stage (18) that precedes the scrubbing zone (4), said quench stage being arranged in the gas inlet (3) of the scrubbing tower (1), and cooled to approximately saturation temperature.

6. A method according to claim 1, wherein the method is carried out in the scrubbing tower (1) at a gas-side pressure loss of less than 15 hPa.

7. A method according to claim 1, wherein a fluid stream is drawn from the scrubber sump (2), mixed with air, using water jet pumps (20), and passed back to the scrubber sump (2).

8. A method according to claim 1, wherein the gas leaving the wet electrofilter (13) is passed off into the environment via a chimney (21) arranged above the filter (13).

9. A system for removing sulfur and dust from waste gases, comprising:
a scrubbing tower (1), which has a scrubber sump (2), a gas inlet (3) above the scrubber sump (2), and a scrubbing zone (4) with spray nozzles (5) at an upper end of the scrubbing zone (4);
a scrubbing fluid circulation system (6), which connects the scrubber sump (2) with the spray nozzles (5) and having a device (7) to transport the scrubbing fluid (8) from the scrubber sump (2) to the spray nozzles (5);
a metering device (9) for absorbents connected to the scrubbing tower;
devices (10) for gasification of the scrubbing fluid (8) with air, said devices being connected to the scrubber sump;
devices (11) for thickening a suspension stream (12) that is drawn from the scrubber sump (2);
a wet electrofilter (13) having precipitation electrodes (14), through which vertical flow takes place, arranged in a segment of the scrubbing tower (1) above the scrubbing zone (4); and
a flushing device connected with the scrubbing fluid circulation system (6) for cleaning of the precipitation electrodes (14).

10. A system according to claim 9, wherein the metering device (9) for absorbents is connected with the scrubbing fluid circulation system (6).

11. A system according to claim 9, further comprising a quenching device (18) having spray nozzles (5) arranged in the gas inlet (3), said quenching device (18) being connected with the scrubbing fluid circulation system (6).

12. A system according to claim 9, wherein the device (10) for gasification of the scrubbing fluid is arranged in a circulation line (19) connected with the scrubber sump (2), and has water jet pumps (20), through which the scrubbing fluid (8) flows and which draw air into the fluid stream (8).

13. A system according to claim 9, wherein the scrubbing tower (1) has a chimney (21) at a top region, for emission of the gas cleaned in the wet electrofilter (13) into the environment.
